(19) United States
(12) Patent Application Publication
(10) Pub. No.: US 2026/0116495 A1
(43) Pub. Date: Apr. 30, 2026

(54) DEVICE FOR A BICYCLE, BICYCLE, AND METHOD FOR OPERATING A DEVICE FOR A BICYCLE

(71) Applicant: Porsche eBike Performance GmbH, Ottobrunn (DE)

(72) Inventors: Pedro Barbieri Figueiredo Ferreira, Munich (DE); Stefan Brand, Munich (DE)

(21) Appl. No.: 19/373,526

(22) Filed: Oct. 29, 2025

(30) Foreign Application Priority Data
Oct. 30, 2024 (DE) 10 2024 131 779.5

(51) Int. Cl. B62M 6/55; F16D 41/26

(52) U.S. Cl. CPC B62M 6/55; F16D 41/26

(57) ABSTRACT

The device has two coupling elements mounted rotatably about a rotation axis and movable axially relative to each other. In a first axial relative arrangement of the two coupling elements, these are coupled to each other such that, at least when the first coupling element rotates in a first direction, torque can be transmitted from the first to the second coupling element. Via rotation of the first coupling element in a second direction, the two coupling elements can be moved axially apart at least until they reach a second axial relative arrangement. In the second axial relative arrangement, movement of a movable blocking element into a blocking position is enabled or enablable. With the blocking element in the blocking position and the coupling elements in the second axial relative arrangement, axial movement of the two coupling elements toward each other is blocked.

### CROSS-REFERENCE TO RELATED APPLICATIONS

This application claims priority of German patent application no. 10 2024 131 779.5, filed Oct. 30, 2024, the entire content of which is incorporated herein by reference.

### TECHNICAL FIELD

A device for a bicycle is described. In addition, a bicycle and a method for operating a device for a bicycle are described.

### BACKGROUND

Bicycles are a cost-effective, easy-to-use, and emission-free means of transportation. They have also become popular as sports and fitness equipment, and certain types have proven to be particularly suitable for various sporting activities.

In recent years, enthusiasm for electric bicycles (especially so-called “pedelecs”) has also been growing, despite their high weight and price compared to conventional bicycles. With bicycles, but especially with expensive electric bicycles, it is important to protect them from theft.

### SUMMARY

It is an object of the disclosure to provide a compact device for a bicycle that contributes to reliable and secure theft protection. Further objects include to specify a bicycle with such a device and a method for operating such a device.

First, the device for a bicycle is specified. The device is particularly for an electric bicycle.

In at least one embodiment, the device has a first coupling element, a second coupling element, and a movable blocking element. The two coupling elements are mounted so that they can rotate about a rotation axis and are mounted so that they can move axially relative to each other. The device is configured such that, in a first axial relative arrangement of the two coupling elements, they are coupled to each other in such a way that, at least when the first coupling element rotates in a first rotational direction, torque can be transmitted from the first coupling element to the second coupling element. With the help of a rotation of the first coupling element in a second rotational direction, the two coupling elements can be moved axially apart at least up to a second axial relative arrangement. In addition, in the second axial relative arrangement, movement of the blocking element into a blocking position is enabled or can be enabled. With the blocking element in the blocking position and the coupling elements in the second axial relative arrangement, axial movement of the two coupling elements toward each other is blocked.

The present disclosure is based, among other things, on the idea of decoupling two elements that are coupled to each other for torque transmission during normal operation and preventing recoupling by inserting a blocking element. For example, the pedal shaft can be decoupled from the output shaft in this way. If a thief attempts to steal the bicycle, he cannot propel the bicycle forward by pedaling. The decoupling and blocking of recoupling takes place in two stages. First, moving the two coupling elements axially apart allows the blocking element to be brought into the blocking position. Recoupling is then prevented by the blocking element actually being moved into the blocking position. This two-stage process reduces the risk of accidental locking of the coupling between the two coupling elements, for example while riding a bicycle. This increases safety in particular.

The two coupling elements are mounted in the device so that they can rotate around the same rotation axis. Here and in the following, the axial direction is understood to be a direction parallel, in particular along, this rotation axis. A radial direction is the respective direction perpendicular to the rotation axis, and an azimuthal direction or rotational direction is a direction around the rotation axis.

The two coupling elements are each mounted so that they can rotate relative to a housing of the device. The housing is, for example, a motor housing and/or a gearbox housing of the device. In particular, the housing can be a bottom bracket housing. The coupling elements can each be cylindrical, in particular ring-shaped or disc-shaped or bushing-shaped. The relative axial mobility between the coupling elements can be achieved by both coupling elements being mounted in the housing so that they are axially movable, or by only one of the coupling elements being mounted in the housing so that it is axially movable and the other being fixed axially in the housing. For example, the first coupling element is mounted in the housing so that it is axially movable and the second coupling element is fixed axially. Axial mobility can be achieved by arranging the respective coupling element on a shaft via a plug-in gearing.

Here and in the following, an axial relative arrangement is understood to mean a specific axial position of the first coupling element relative to the second coupling element. In particular, different axial relative arrangements differ in the axial distance between the first and second coupling elements. For example, the first axial relative arrangement is the arrangement in which the two coupling elements are closest to each other axially.

In the first axial relative arrangement, the two coupling elements are coupled to each other. The coupling can be established by friction and/or form fit. In particular, the two coupling elements realize a clutch. The coupling is configured for torque transmission from the first coupling element to the second coupling element, at least when the first coupling element is rotated in the first rotational direction. In one embodiment, torque can also be transmitted from the first to the second coupling element when rotating in the opposite, second rotational direction. In another embodiment, in the first axial relative arrangement, that is, in the coupled state of the two coupling elements, torque can only be transmitted from the first coupling element to the second coupling element when the first coupling element rotates in the first rotational direction.

In the first axial relative arrangement, for example, the first coupling element cannot rotate faster in the first rotational direction than the second coupling element coupled to it. In the first axial relative arrangement, the second coupling element can rotate faster in the first rotational direction than the first coupling element, or the second coupling element cannot rotate faster in the first rotational direction than the first coupling element.

The device is configured so that the two coupling elements can be moved axially apart by rotating the first coupling element in the second rotational direction. This means that the rotation leads to the axial movement. For example, in the first axial relative arrangement, rotation of the first coupling element relative to the second coupling element in the second rotational direction is already possible and already leads to axial separation.

The two coupling elements can be moved apart at least into a second axial relative arrangement. This means that the second axial relative arrangement is an arrangement in which the two coupling elements are further apart axially than in the first axial relative arrangement. In particular, the two coupling elements are then so far apart that the coupling between them is released. In this second axial relative arrangement, for example, each of the two coupling elements can rotate in the first and/or second rotational direction independently of the other coupling element. This means that the first coupling element can, for example, rotate in the first rotational direction without the second coupling element rotating in the first rotational direction. In particular, in the second axial relative arrangement, torque transmission from the first to the second coupling element is deactivated, that is, not possible, regardless of the rotational direction.

The device has a movable blocking element. The blocking element can be cylindrical. For example, the blocking element is a pin- or bolt-shaped element. When the two coupling elements are in the second axial relative arrangement, movement of the blocking element into a blocking position is enabled or can be enabled. For example, before reaching the second axial relative arrangement, movement of the blocking element into the blocking position is blocked, in particular by one of the two coupling elements. The movement of the blocking element into the blocking position is, for example, a radial and/or azimuthal movement. For example, the blocking element is fixed axially and/or azimuthally, that is, it is immovable in this direction or these directions relative to the housing.

With the blocking element in the blocking position and the coupling elements in the second axial relative arrangement, axial movement of the two coupling elements toward each other is blocked. For example, the blocking element blocks the axial displacement of one of the two coupling elements in the direction of the other coupling element. For example, the blocking element blocks the axial movement of the first coupling element toward the second coupling element. When attempting to move the two coupling elements axially toward each other, one of the coupling elements, for example, abuts axially and/or azimuthally against the blocking element.

According to at least one embodiment, in the second axial relative arrangement, the first coupling element is rotatable relative to the second coupling element in the first rotational direction. Alternatively or additionally, in the second axial relative arrangement, the second coupling element is rotatable relative to the first coupling element in the first rotational direction.

According to at least one embodiment, in the second axial relative arrangement, a complete rotation or revolution of the first and/or second coupling element in the first rotational direction is blocked. This means that at least one of the two coupling elements cannot be rotated through 360° along the first rotational direction in the second axial relative arrangement. For example, rotation through more than 180° or more than 90° or more than 30° in the first rotational direction is already blocked.

According to at least one embodiment, the blocking of rotation in the first rotational direction is achieved by the respective coupling element or an element connected to the coupling element in a rotationally fixed manner striking a rotationally secured stop element. The stop element is, for example, coupled to the housing or is part of the housing.

The fact that the stop element is rotationally secured means that it cannot be rotated, or can only be rotated to a limited extent, at least in the first rotational direction, but preferably cannot be rotated in either of the two rotational directions, or can only be rotated to a limited extent in either of the two rotational directions. For example, the stop element is coupled to the housing via a plug-in gearing. The stop element may have a shape, for example a hexagonal shape, which jams in the housing when an attempt is made to rotate it and then cannot be rotated further.

According to at least one embodiment, one of the coupling elements or an element coupled in a rotationally fixed manner to this coupling element has a stop area that overlaps axially, preferably also radially, with the rotationally secured stop element in the second axial relative arrangement, so that when the coupling element rotates in the first rotational direction, the stop area strikes the stop element. The abutment can block (further) rotation in the first rotational direction. The axial and optional radial overlap can be achieved by interlocking the stop element and the stop area. The interlocking is, for example, a formfitting interlocking, in particular with a form fit in the rotational direction.

According to at least one embodiment, the stop area and the stop element do not overlap axially in the first axial relative arrangement and preferably also in the third axial relative arrangement introduced below, that is, the stop area and the stop element are arranged axially offset from each other here. Then, when rotating in the first rotational direction, the stop area does not strike the stop element. This means that the stop element does not block the rotation of the coupling element in the first rotational direction. In the first and/or third axial relative arrangement, the stop element and the stop area may overlap radially.

The stop area can be or include a stop surface. The stop surface is directed in the first rotational direction, for example. The fact that the stop area overlaps axially with the stop element means that the stop area is arranged in the axial direction at least partially in the same position or height as the stop element. Respective applies to radial overlap.

According to at least one embodiment, both the first and second coupling elements have a stop area, or both the first and second coupling elements are coupled in a rotationally fixed manner to a stop area. Each of the coupling elements can then be assigned a stop element against which, when the second axial relative arrangement is assumed, the respective stop area strikes when rotating in the first rotational direction. All features disclosed above and below for a coupling element with an associated stop area hall apply correspondingly if several coupling elements is each assigned a stop area. For example, a separate stop element is then provided for each coupling element.

According to at least one embodiment, the stop element is a bolt or includes a bolt. The stop area may be a ring-shaped or washer-shaped area in which one or more recesses, in particular pockets, are provided. In the second axial relative arrangement, the bolt protrudes into a recess. In the first and third axial relative arrangements, the bolt is outside the recess(es).

According to at least one embodiment, the stop element extends partially or completely around the rotation axis. For example, the stop element is ring-shaped or washer-shaped. The stop element includes, for example, a toothing. In this case, the stop area can also be ring-shaped or washer-shaped and have a toothing. The two toothings are, for example, crown toothings, that is, provided in respective end faces. In the second axial relative arrangement, the two toothed elements then engage with each other, thereby blocking rotation in the first rotational direction.

According to at least one embodiment, the stop element is mounted so that it can move axially, in particular so that it can move axially relative to the housing. This can be achieved via a plug-in toothing between the housing and the stop element.

For example, the stop element is coupled to one of the two coupling elements, in particular to the first coupling element, in such a way that when this coupling element is axially displaced from the first axial relative arrangement to the second axial relative arrangement, the stop element is also axially displaced and thereby brought into axial overlap with the stop area of the other coupling element, in particular of the second coupling element.

According to at least one embodiment, the stop element is coupled to a spring in order to bias the stop element axially toward the stop area. In particular, the stop element can be biased axially toward the stop area in the second axial relative arrangement. Since the coupling elements can rotate, but the stop element cannot or can only rotate to a limited extent, it may not be possible to establish axial overlap between the stop area and the stop element in every rotational position of the stop area. However, by biasing towards the stop area, in the second axial relative arrangement and when the stop area rotates, a rotational position of the stop area is eventually reached in which axial overlap becomes possible and is automatically created by the biasing.

The stop element can be coupled to the housing via the spring, or the stop element can be coupled to one of the two coupling elements, in particular to the first coupling element, via the spring.

According to at least one embodiment, in an axial relative arrangement in which the two coupling elements are axially closer to each other than in the second axial relative arrangement, movement of the blocking element into an intermediate position is enabled or can be enabled. The blocking element in the intermediate position engages in a recess which is arranged immovably relative to the first or second coupling elements and which is bounded by a surface inclined with respect to the rotation axis.

The aforementioned axial relative arrangement is, for example, the first axial relative arrangement or a third axial relative arrangement. In the third axial relative arrangement, the distance between the two coupling elements lies between the distance in the first axial relative arrangement and the distance in the second axial relative arrangement. In the third axial relative arrangement, the two coupling elements are, for example, decoupled. In particular, in the third axial relative arrangement, the first coupling element can be rotated relative to the second coupling element in the first rotational direction. Torque transmission between the coupling elements is not possible in the third axial relative arrangement, for example, regardless of the rotational direction.

The device is configured, for example, such that the transition from the first axial relative arrangement to the third axial relative arrangement can be achieved by rotating the first coupling element relative to the second coupling element in the second rotational direction. If, for example, the two coupling elements in the first axial relative arrangement are in toothed engagement with each other, the toothing can be selected such that rotation of the first coupling element relative to the second coupling element in the second rotational direction automatically leads to a separation of the two coupling elements. This is particularly possible if the coupling elements are freewheel elements, that is, the coupling is a freewheel coupling.

The recess is immovable relative to the first or second coupling element. For example, the recess is provided in the first coupling element or in the second coupling element. The recess is provided, for example, in a lateral surface, that is, in a surface directed radially outward. The recess has a depth measured in the radial direction, an axial extension, and an azimuthal extension. The depth is, for example, less than, for example, at most half as large as the azimuthal and axial extensions. The azimuthal extension may be greater than, for example, at least twice the axial extension.

The inclined surface extends, for example, in the azimuthal, radial, and axial directions. For example, the inclined surface is a flat surface that bounds the recess. The recess can be triangular in shape when viewed from above. For example, several such recesses are provided around the rotation axis, that is, azimuthally one behind the other. All recesses can be identical in configuration. For example, the recesses are evenly distributed around the rotation axis. The recesses can all be arranged at the same height or position in the axial direction.

The intermediate position of the blocking element is, for example, a position between an initial position of the blocking element and the blocking position. The initial position is the position of the blocking element that it occupies during normal operation of the bicycle, that is, when no decoupling of the coupling elements is intended. In the initial position, the blocking element is spaced apart from the coupling elements in particular so that it cannot impede their movements either in the rotational directions or in the axial directions. For example, in the blocking position, the blocking element is offset further radially inwards, that is, in the direction of the rotation axis, than in the intermediate position.

According to at least one embodiment, starting from the aforementioned axial relative arrangement and with the blocking element in the intermediate position, rotation of the first coupling element in the second rotational direction causes the blocking element to move along the inclined surface. The inclined surface is selected such that this results in axial displacement of the two coupling elements away from one another. In particular, upon rotation of the first coupling element in the second rotational direction, the blocking element bears against the inclined surface. The inclined surface then acts, for example, as a cam on the blocking element, thereby automatically causing the two coupling elements to move apart axially.

According to at least one embodiment, the device is configured so that the blocking element is automatically moved into the blocking position as soon as the second axial relative arrangement is reached. For example, before the second axial relative arrangement is reached, a force can be exerted on the blocking element, which acts in the direction of the blocking position. However, movement into the blocking position is prevented and is only automatically enabled when the second axial relative arrangement is reached.

For example, the force is exerted on the blocking element by a biased spring element of the device. The force is directed radially inward, that is, toward the rotation axis.

According to at least one embodiment, the blocking element is movable into a waiting position. In an axial relative arrangement of the coupling elements outside the second axial relative arrangement, the blocking element rests against the first or second coupling element in this waiting position, and a force is exerted on the blocking element, which presses the blocking element toward the blocking position against the respective coupling element. The contact with the first or second coupling element prevents or blocks movement of the blocking element into the blocking position.

In other words, the first or second coupling element blocks the path of the blocking element into the blocking position when the two coupling elements are not in the second axial relative arrangement. The blocking element is pressed against a surface of the first or second coupling element, for example, and rests against it. The force is applied by a preloaded spring element, such as a coil spring, for example. The force is built up when moving into the waiting position, for example.

The waiting position is a position between the initial position and the blocking position. The waiting position can be a position between the initial position and the intermediate position.

According to at least one embodiment, the device has an actuator. The actuator is configured to move the blocking element or to release a movement and/or to exert a force on the blocking element in the direction of the blocking position.

According to at least one embodiment, the device has a control unit that is connected to the actuator via signals. The control unit is configured to generate a control signal. The control signal causes the actuator to move the blocking element to the waiting position or to release movement into the waiting position. For example, the control signal causes the actuator to move the blocking element from the initial position to the waiting position. Alternatively, the blocking element can be preloaded in the direction of the waiting position, for example via a spring element, whereby movement into the waiting position is blocked. The actuator can then release this movement. With a further control signal from the control unit, the actuator can be caused to move the blocking element out of the blocking position, for example back into the initial position.

The actuator is, for example, a linear drive. The actuator can be an electric or magnetic actuator. In one embodiment, the actuator can move the blocking element into the waiting position, thereby biasing the spring element. Or the spring element is already biased in the initial position and the actuator releases a movement of the blocking element into the waiting position driven by the biased spring element. The biased or still biased spring element then exerts the force on the blocking element in the direction of the blocking position, thereby pressing the blocking element against the respective coupling element. As soon as the path to the blocking position is released for the blocking element, the blocking element automatically moves into the blocking position.

Instead of the actuator, an electric motor can also be used to move the blocking element. The electric motor is coupled to a gearbox, for example. The gearbox can in turn be coupled to an output shaft so that, for example, torque can be transmitted from the electric motor to the output shaft via the gearbox. With the aid of the electric motor, the blocking element can, for example, be moved from the initial position to the waiting position and/or from the blocking position back to the initial position.

According to at least one embodiment, the first or second coupling element has a groove that extends at least partially around the rotation axis. The blocking element in the blocking position protrudes into this groove. The groove extends, for example, annularly around the rotation axis. The groove may extend partially, for example, by at least 30° and at most 180°, or completely around the rotation axis.

The fact that one of the two coupling elements has a groove means that the groove is formed completely in this coupling element. This means that the groove is bounded both in both axial directions and radially inward by this one coupling element.

The groove and the previously described recess with the inclined surface merge into each other, for example. The depth of the groove, measured in the radial direction, is greater than the depth of the recess. In the above-mentioned intermediate position, in which the blocking element protrudes into the recess, the blocking element, for example, rests in the radial direction against the first or second coupling element and is pressed against it, for example, by the biased spring element. Even in the blocking position, the blocking element can rest against the first or second coupling element in the radial direction and can be pressed against it, for example by the biased spring element.

According to at least one embodiment, the movement of the blocking element into the blocking position is a radial movement, in particular a radially inward movement, that is, toward the rotation axis. The movement can be a purely radial movement. For example, the blocking element moves from the initial position to the blocking position by at least 5 mm or at least 10 mm in the radial direction. From the intermediate position or the waiting position to the blocking position, the blocking element moves, for example, by at least 2 mm or at least 5 mm.

According to at least one embodiment, the two coupling elements in the second axial relative arrangement are biased toward each other in the direction of the first axial relative arrangement via a spring element. This spring element is a different spring element than the one mentioned above, which pushes the blocking element toward the blocking position. In other words, in the second axial relative arrangement, a force is exerted via a spring element, which is directed in such a way that it attempts to move the two coupling elements axially toward each other. For example, the device is configured so that this axially acting force acts as soon as the two coupling elements are moved out of the first axial relative arrangement, or it also acts while the two coupling elements are in the first axial relative arrangement. The spring element is arranged between the two coupling elements, for example.

According to at least one embodiment, the two coupling elements are freewheel elements that are in toothed engagement with each other in the first axial relative arrangement.

The device may have two or more movable blocking elements. These may be arranged at different azimuthal positions and may, for example, each be brought into a respective blocking position by a radial movement. For example, the blocking elements protrude into the groove in the second axial relative arrangement and when all blocking elements are in their respective blocking positions. The blocking elements may be coupled via a lever mechanism so that they can all be moved together via the one actuator. All information provided herein regarding one blocking element also applies to all other blocking elements.

According to at least one embodiment, the device is a drive device for a bicycle, in particular for an electric bicycle.

According to at least one embodiment, the first coupling element is coupled to a pedal shaft. In particular, the first coupling element is coupled to the pedal shaft in a rotationally fixed manner so that when the pedal shaft rotates in both rotational directions, the first coupling element is rotated with it. The rotation axis of the pedal shaft may coincide with the rotation axis of the first coupling element. The first coupling element is coupled to the pedal shaft, for example, via a plug-in gearing, for example, by being plugged onto the pedal shaft, so that the first coupling element can be displaced along the pedal shaft.

According to at least one embodiment, the second coupling element is coupled to an output shaft. The second coupling element can be coupled to the output shaft in a rotationally fixed manner so that when the output shaft rotates in both rotational directions, the second coupling element is rotated along with it. The rotation axis of the output shaft may coincide with the rotation axis of the second coupling element. The second coupling element may be fixed axially with respect to the output shaft. For example, the second coupling element is integrally formed with the output shaft. The output shaft may, for example, be connected in a rotationally fixed manner to a chainring or a chainring spider.

The chainring or chainring spider is closed, for example, that is, it has no holes. This prevents a potential thief from coupling a crank arm to the chainring, for example, using a cable tie, thereby removing the decoupling between the pedal shaft and the output shaft. If the chainring or chainring spider is not closed, the above-mentioned blocking of the rotation of the first or second coupling element in the first rotational direction is particularly advantageous, as even a connection between the pedal crank and the chainring or chainring spider via a cable tie would then be useless. The decoupling would be removed, but rotation of the pedal crank shaft or the output shaft would be blocked.

According to at least one embodiment, the output shaft is coupled to an electric motor to transmit torque from the electric motor to the output shaft. For example, the electric motor is coupled to the output shaft via a gearbox. The device is then configured in particular so that the electric motor provides an assistive torque for propelling the bicycle, which can be transmitted to the output shaft. The rotation axis of the rotor of the electric motor can run parallel to the rotation axis of the coupling elements, in particular coinciding with it.

Alternatively, the rotation axis of the rotor of the electric motor may run obliquely or perpendicularly to the rotation axis of the coupling elements. For example, the drive device is a so-called orthogonal drive.

Next, the bicycle is specified. The bicycle is, in particular, an electric bicycle. The bicycle includes a device according to one of the embodiments described herein. For example, the bicycle includes a drive device described herein.

According to at least one embodiment, the first coupling element is rotated in the first rotational direction by pedaling forward. In other words, when the pedal shaft is rotated to propel the bicycle forward, the first coupling element is rotated in the first rotational direction.

According to at least one embodiment, the first coupling element is rotated in the second rotational direction by pedaling backward. In other words, when the pedal shaft is rotated by pedaling backward, the first coupling element is rotated in the second rotational direction. That is, pedaling backward can achieve decoupling of the two coupling elements. In particular, the two coupling elements can be transferred to the second axial relative arrangement by pedaling backwards. For example, the coupling elements can be moved from the first axial relative arrangement to the third axial relative arrangement by pedaling backwards. If the blocking element is then in the intermediate position and protrudes into the recess, the coupling elements can then be moved from the third axial relative arrangement into the second axial relative arrangement by further pedaling backwards.

Next, the method for operating a device is described. The method is particularly useful for setting up anti-theft protection for the bicycle. The method is used to operate a device according to one of the embodiments described herein. In this respect, all features disclosed for the device are also disclosed for the method and vice versa.

In at least one embodiment, the method includes a step in which a force is exerted on the blocking element in the direction of the blocking position. In a further step, the first coupling element is rotated in the second rotational direction until the second axial relative arrangement is reached, whereby in the second axial relative arrangement the movement of the blocking element into the blocking position is enabled and the blocking element automatically moves into the blocking position.

When the force is initially applied to the blocking element, movement of the blocking element into the blocking position is still prevented or blocked. In particular, the axial relative movement of the two coupling elements into the second axial relative arrangement only takes place after the force has been applied to the blocking element. The force is then maintained until the second axial relative arrangement is reached, so that movement into the locking position then occurs automatically.

For example, the force is applied to the blocking element when the two coupling elements are still in the first axial relative arrangement in which they are coupled to each other. The blocking element is then moved from the initial position to the waiting position and pressed against one of the coupling elements in the direction of the blocking position. Subsequently, the distance between the coupling elements is increased by rotating the first coupling element in the second rotational direction until the second axial relative arrangement is reached and the blocking element automatically moves into the blocking position.

In one embodiment, starting from the first axial relative arrangement, the distance between the two coupling elements is increased by rotating the first coupling element relative to the second coupling element in the second rotational direction until the third axial relative arrangement is reached. In this third axial relative arrangement, the blocking element then automatically moves from the waiting position into the recess and reaches the intermediate position. By further rotating the first coupling element, the blocking element adjoining the inclined surface of the recess pushes the two coupling elements further apart axially until the second axial relative arrangement is finally reached. The force is exerted, for example, by a biased spring element.

According to at least one embodiment, the method includes a further step in which a control signal is generated for the actuator. The control signal then causes the actuator to move the blocking element into the waiting position or to release movement into the waiting position, whereupon the blocking element automatically moves into the waiting position.

The control signal is generated in particular by the control unit. For example, an activation signal is first transmitted to the control unit, for example wirelessly, using an external device, such as a smartphone. The control unit is configured to generate the control signal in response to the activation signal. The control unit is part of the bicycle, in particular of the device.

According to at least one embodiment, the first coupling element rotates in the second rotational direction by pedaling backwards.

An example of how the device works is as follows: A cyclist rides their bicycle to a specific location where they want to park it safely. When they reach the location, they use their smartphone to generate an activation signal that causes the control unit to generate the control signal. The control signal is sent to the actuator, which then moves the blocking element into the waiting position or releases the movement into the waiting position. In the waiting position, a force acts on the blocking element in the direction of the blocking position. The rider can now pedal backwards until the blocking element automatically moves into the blocking position. The two coupling elements can now no longer be coupled with each other because this is blocked by the blocking element. Consequently, pedaling forwards can no longer transfer torque from the pedal shaft to the output shaft. The bicycle can therefore no longer be operated manually.

### BRIEF DESCRIPTION OF DRAWINGS

The invention will now be described with reference to the drawings wherein:

FIG. 1 shows an embodiment of an electric bicycle;

FIGS. 2 to 4 show different situations in an embodiment of the method for operating an embodiment of the device;

FIGS. 5 to 8 show different situations in a further embodiment of the method for operating a further embodiment of the device;

FIG. 9 shows yet another embodiment of the device;

FIGS. 10 and 11 show situations in a further embodiment of the method for operating a further embodiment of the device;

FIGS. 12 and 13 show situations in a further embodiment of the method for operating a further embodiment of the device;

FIGS. 14 and 15 show details of the embodiment of the device of FIGS. 10 and 11 in different views;

FIG. 16 shows a further embodiment of the device; and,

FIG. 17 shows a part of the device of FIG. 16 in another view.

### DETAILED DESCRIPTION

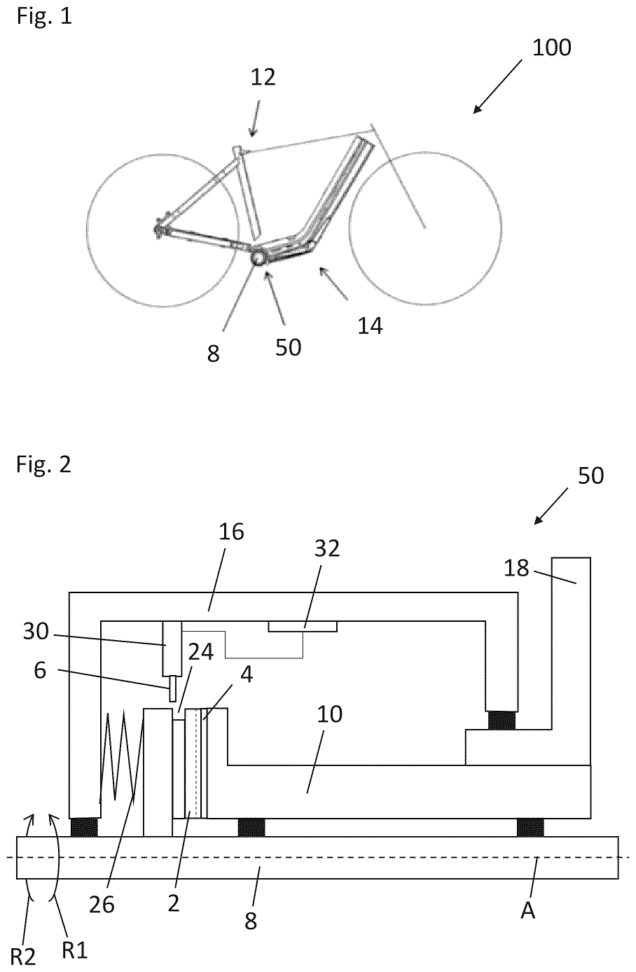

FIG. 1 schematically shows an electric bicycle 100 with a bicycle frame 12. A lower frame section 14 of the bicycle frame 12 forms a down tube 14. The down tube 14 extends in the direction of a bottom bracket of the electric bicycle 100. The bottom bracket has a pedal shaft 8. The pedal shaft 8 is part of a drive device 50 installed in the bicycle 100.

FIG. 2 shows an embodiment of this drive device 50. The drive device 50 includes a housing 16, which forms, for example, a bottom bracket housing. The pedal shaft 8 extends through the housing 16. The pedal shaft 8 is mounted rotatably about a rotation axis A. A first coupling element 2 and a second coupling element 4 are arranged inside the housing 16.

The two coupling elements 2, 4 are located here in a first axial relative arrangement in which they are coupled to each other. In the present case, the two coupling elements 2, 4 are freewheel elements which, when coupled, are in toothed engagement with each other. Rotation of the first coupling element 2 in a first rotational direction R1 transfers torque to the second coupling element 4, causing the second coupling element 4 to rotate. In the opposite, second rotational direction R2, the first coupling element 2 cannot transfer torque to the second coupling element 4. The first rotational direction R1 and the second rotational direction R2 are shown in FIG. 2.

The first coupling element 2 includes a groove 24 provided in the outer surface, that is, in the radial outer surface, of the first coupling element 2. The groove 24 has, for example, a depth of at least 5 mm. The groove 24 can extend completely around the rotation axis A. The first coupling element 2 is coupled to the pedal shaft 8 in a rotationally fixed manner. Axially, that is, in the direction parallel to the rotation axis A, the first coupling element 2 can, for example, be moved relative to the pedal shaft 8. The rotationally fixed but axially movable coupling between the first coupling element 2 and the pedal shaft 8 is achieved, for example, by a coupling via a plug-in gearing.

The second coupling element 4 is in a rotationally fixed manner coupled to an output shaft 10 of the drive device 50. The output shaft 10 includes a chainring 18 or is in a rotationally fixed manner connected to it. Like the pedal shaft 8, the output shaft 10 is mounted so that it can rotate about the rotation axis A. The second coupling element 4 is, for example, fixed axially to the output shaft 10, meaning that it cannot be moved axially relative to the output shaft 10.

If the two coupling elements 2, 4 are coupled to each other, the pedal shaft 8 can be rotated in the first rotational direction R1 by pedaling forward. The torque of the pedal shaft 8 is transmitted to the output shaft 10 via the coupling between the coupling elements 2, 4, thereby propelling the bicycle forward. By pedaling backwards, the first coupling element 2 can be rotated in the second rotational direction R2. The axial mobility of the first coupling element 2 and the freewheel coupling between the two coupling elements 2, 4 causes the two coupling elements 2, 4 to be driven apart axially during this rotation. However, a spring element 26 in the form of a spring always pushes the first coupling element 2 in the direction of the second coupling element 4, so that when backward pedaling is stopped and the axial movement of the first coupling element 2 is not blocked, the two coupling elements 2, 4 are automatically coupled together again.

The drive device 50 of FIG. 2 further includes an actuator 30 and a control unit 32, which are signally coupled to each other. A blocking element 6 is arranged in the axial direction at the height of the first coupling element 2 and spaced radially apart from the first coupling element 2. The blocking element 6 is a bolt or pin that can be moved radially with the aid of the actuator 30, in particular in the radial direction toward the first coupling element 2.

The position of the blocking element 6 shown in FIG. 2 is referred to as the initial position. This position is assumed during normal operation of the electric bicycle 100. In this initial position, the blocking element 6 does not influence the movement of the first coupling element 2.

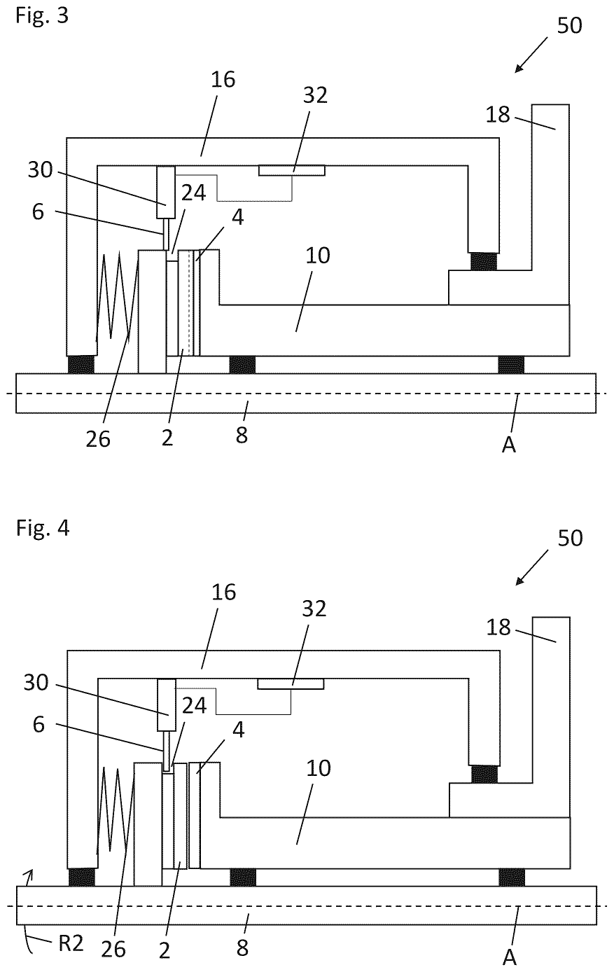

FIG. 3 shows a situation in the process in which the actuator 30 has moved the blocking element 6 radially inward until the blocking element 6 has arrived in a waiting position. In this position, the blocking element 6 is pressed radially inward against the first coupling element 2. To achieve this, the rider has, for example, parked the bicycle and sent an activation signal wirelessly to the control unit 32 via their smartphone. Depending on the activation signal, the control unit 32 has generated a control signal, sent it to the actuator 30, and the actuator 30 has then moved the blocking element 6 radially inward. For example, the actuator 30 was used to tension a spring (not shown) which, in the waiting position shown in FIG. 3, presses the blocking element 6 radially inward against the first coupling element 2.

In the situation shown in FIG. 4, the two coupling elements 2, 4 are now axially further apart than in FIGS. 1 and 2 due to a movement of the first coupling element 2 axially to the left. In particular, the coupling elements 2, 4 are now in a second axial relative arrangement in which the coupling between the two coupling elements 2, 4 is released, that is, they no longer engage with each other. The first coupling element 2 can now rotate freely relative to the second coupling element 4 in the first rotational direction R1. Torque transmission from the first coupling element 2 to the second coupling element 4 is now no longer possible.

In order to move from the first axial relative arrangement of FIGS. 2 and 3 to the second axial relative arrangement of FIG. 4, the first coupling element 2 was rotated in the second rotational direction R2, for example by pedaling backwards. The toothing of the freewheel coupling caused the two coupling elements 2, 4 to be pushed apart against the restoring force of the spring 26.

The device 50 of FIGS. 2 to 4 is configured so that, in the second axial relative arrangement of the two coupling elements 2, 4, the blocking element 6 is axially at the position of the groove 24. The force acting radially inward on the blocking element 6 has caused the blocking element 6 to automatically engage in the groove 24 when the second axial relative arrangement is reached and is now in a blocking position. With the blocking element 6 in this blocking position, axial movement of the first coupling element 2 in the direction of the second coupling element 4 is blocked, namely by the blocking element 6 striking a surface of the first coupling element 2 that delimits the groove 24. However, this means that the coupling between the two coupling elements 2, 4 cannot be reestablished. The bicycle can no longer be propelled forward by pedaling. This effectively configures theft protection.

The anti-theft protection can be deactivated, for example, by an opening signal sent from the smartphone to the control unit 32. Depending on the opening signal, the control unit 32 then generates another control signal that causes the actuator 30 to pull the blocking element 6 radially outwards from the groove 24 to its initial position, so that the two coupling elements 2, 4 can be coupled together again.

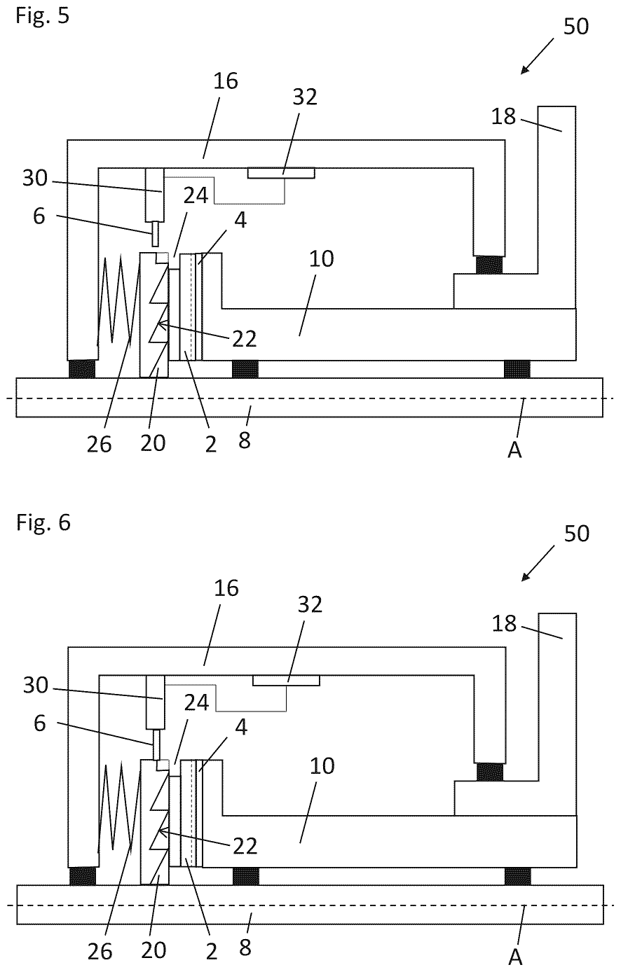

FIG. 5 shows another embodiment of the drive device 50. The drive device is similar to that shown in FIGS. 2 to 4. One difference is that the first coupling element 2 now has a plurality of recesses 20 distributed around the rotation axis A. The recesses 20 are triangular in shape when viewed from above, looking radially inward. They merge directly into the groove 24 and have an inclined surface 22 on the side facing away from the groove 24.

In FIG. 5, the two coupling elements 2, 4 are coupled to each other as in FIG. 2. The blocking element 6 is located in the initial position radially spaced from the first coupling element 2.

FIG. 6 shows a situation in the method that was achieved by sending an activation signal, for example via a smartphone, in response to which the control unit 32 generated a control signal. The control signal caused the actuator 30 to move the blocking element 6 radially inward into the waiting position. Here, the blocking element 6 is pressed against the outer surface of the first coupling element 2. In the first axial relative arrangement between the two coupling elements 2, 4 of FIG. 6, the blocking element 6 is pressed against the first coupling element 2 outside the recesses 20 and outside the groove 24.

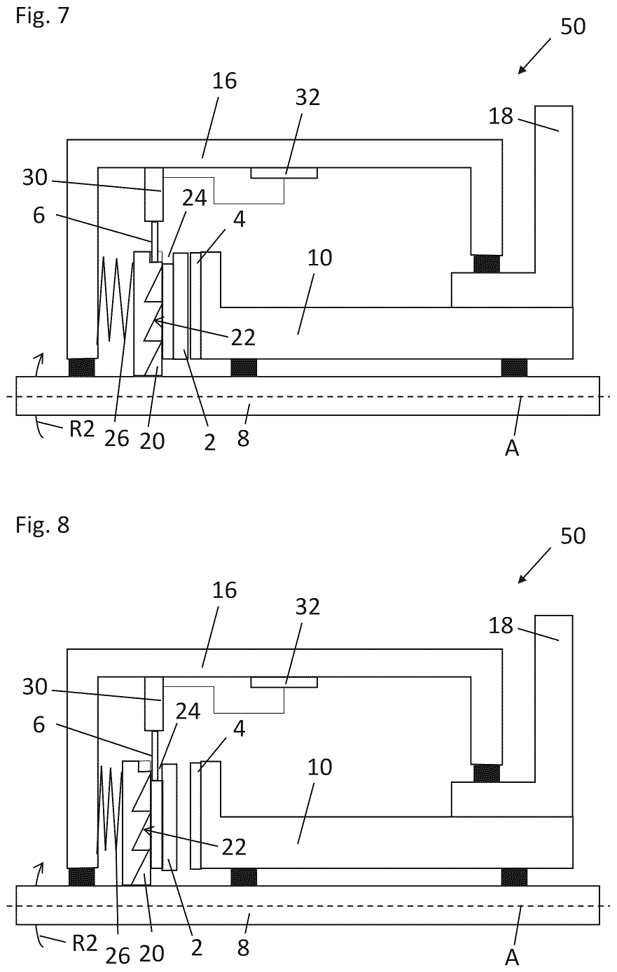

FIG. 7 shows a situation in the method in which, by pedaling backward and the associated rotation of the first coupling element 2 relative to the second coupling element 4 in the second rotational direction R2, the first coupling element 2 was moved axially to the left away from the second coupling element 4 until a third axial relative arrangement was reached in which the coupling of the two coupling elements 2, 4 is released. This third axial relative arrangement is selected with respect to the axial position of the blocking element 6 in such a way that the blocking element 6 can now protrude into one of the recesses 20. The movement of the blocking element 6 into one of the recesses 20 occurs automatically due to the force acting radially inward on the blocking element 6.

In the recess 20, the blocking element 6 is still pressed radially against the coupling element 2 due to the acting force, namely against a bottom surface of the recess 20. The position of the blocking element 6 shown here is referred to as the intermediate position.

By further pedaling backward and thereby rotating the first coupling element 2 in the second rotational direction R2, the inclined surface 22 of the recess 20, into which the blocking element 6 now protrudes, eventually strikes the blocking element 6. Since the blocking element 6 is axially immovable, further rotation of the first coupling element 2 in the second rotational direction R2 causes a further axial displacement of the first coupling element 2 to the left away from the second coupling element 4. As soon as the groove 24 of the first coupling element 2 arrives axially at the position of the blocking element 6, the blocking element 6 automatically moves radially inward into the groove 24 due to the force still acting radially inward. The situation then achieved is shown in FIG. 8.

The axial relative arrangement between the two coupling elements 2, 4 shown in FIG. 8 is the second axial relative arrangement. Once again, a coupling between the two coupling elements 2, 4 cannot be established with the blocking element 6 in the illustrated blocking position, which ultimately provides theft protection.

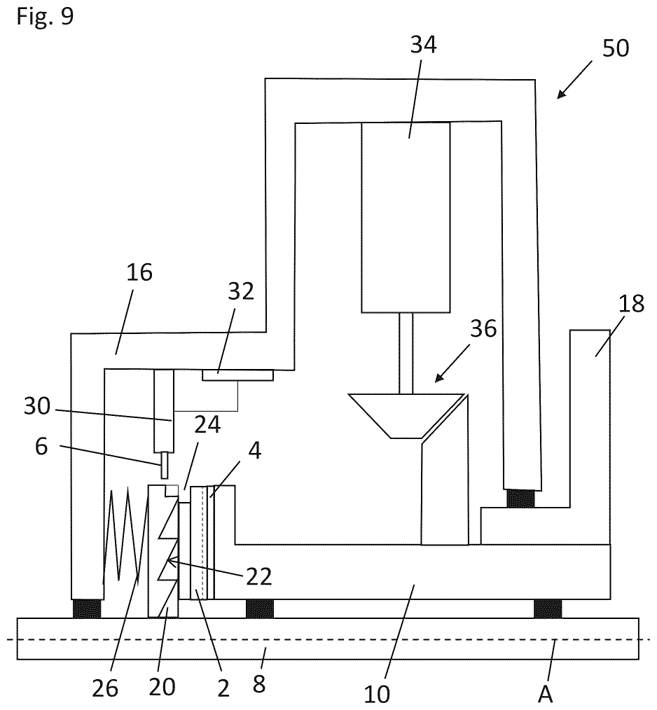

FIG. 9 shows another embodiment of the drive device 50. This is a drive device 50 for an electric bicycle. In addition to the previous embodiment, the drive device 50 also includes an electric motor 34, which is coupled to the output shaft 10 via a gearbox 36 in order to transmit a torque supporting the propulsion to the output shaft 10. The drive device 50 is a so-called orthogonal drive.

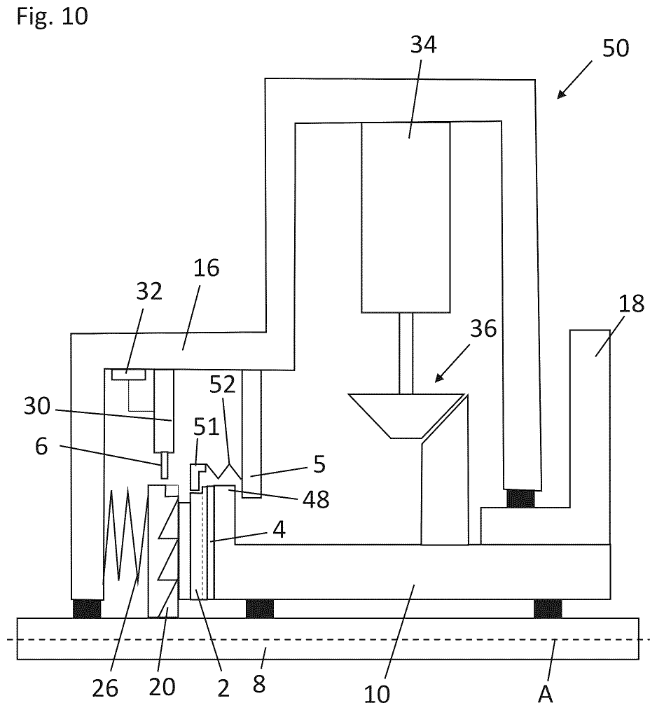

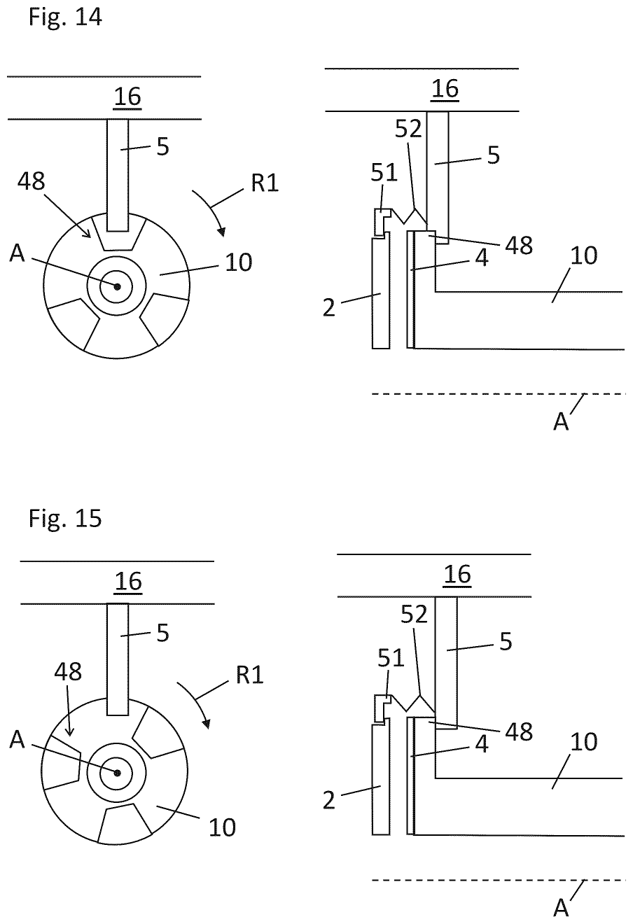

FIG. 10 shows an embodiment of the device 50 in which a flange of the output shaft 10 has a stop area 48. Several recesses or pockets are provided in the stop area 48 (see also FIGS. 14 and 15). In addition, a stop element 5 in the form of a bolt is provided, which is coupled to the housing 16 in a rotationally secured manner. The stop element 5 is axially movable relative to the housing 16.

The stop area 48 overlaps with the stop element 5 in the radial direction, but not in the axial direction. This means that the stop element 5 does not block the rotation of the second coupling element 4 in the first rotational direction R1 in the illustrated first axial relative arrangement between the first 2 and second 4 coupling elements.

The stop element 5 is also coupled to a ring 51 via a spring 52. The ring 51 is coupled to the second coupling element 2 in a form-fitting manner in such a way that the second coupling element 2 can rotate relative to the ring 52, but axial movement of the first coupling element 2 to the left pulls the ring 52 along with it. The stop element 5 is then also pulled to the left via the spring 52.

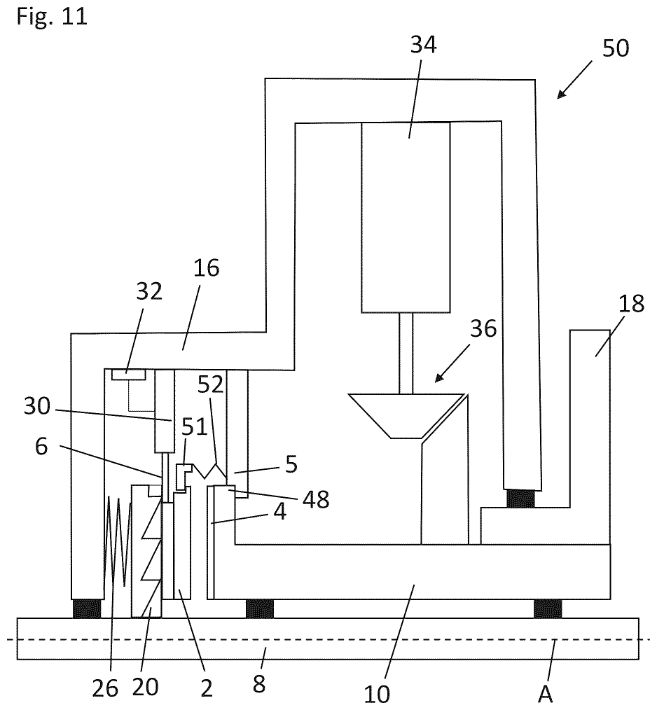

FIG. 11 shows the device 50 of FIG. 10 after the coupling elements 2, 4 have assumed the second axial relative arrangement. The first coupling element 2 has been displaced axially to the left, pulling the stop element 5 with it. The stop element 5 now overlaps not only radially but also axially with the stop area 48, as the stop element 5 engages in one of the recesses. When attempting to rotate the output shaft 10 in the first rotational direction R1, a stop surface of the stop area 48, which azimuthally limits the recess, strikes the stop element 5, thereby blocking the rotation of the output shaft 10 in the first rotational direction R1.

FIGS. 14 and 15 illustrate why the stop element 5 is coupled to the ring 51 via a spring 52. FIGS. 14 and 15 each show a section of the device 50 of FIGS. 10 and 11. In each case, the left image shows a top view with a viewing direction along the axial direction, while the right image, in each case, shows the side view as used in FIGS. 10 and 11. FIGS. 14 and 15 also show the situation in which the first 2 and second 4 coupling elements are in the second axial relative arrangement.

In FIG. 14, the second coupling element 4 and the associated output shaft 10 are in a rotational position such that a recess in the stop area 48 overlaps azimuthally with the stop element 5. Consequently, the stop element 5 can engage in the recess. This blocks the rotation of the coupling element 4 or the output shaft 10 in the first rotational direction R1.

In FIG. 15, on the other hand, the rotational position of the coupling element 4 or the output shaft 10 is such that the recesses are azimuthally offset from the stop element 5. Here, the stop element 5 does not yet engage in a recess, and thus the rotation of the coupling element 4 or the output shaft 10 in the first rotational direction R1 is not yet blocked. However, the stop element 5 is axially biased in the direction of the stop area 48 by the spring 52 and is pressed axially against the flange of the output shaft 10 by the spring 52 (see right-hand image). Rotation of the output shaft 10 together with the coupling element 4 in the first rotational direction R1 then causes a recess to overlap azimuthally with the stop element 5 at some point, and the stop element 5 then automatically moves into the recess. From then on, the rotation of the coupling element 4 or the output shaft 10 in the first rotational direction R1 is blocked.

Unlike in the figures, the stop area 48 could also have more recesses, so that a toothing is formed on the front surface of the flange. The stop element 5 could extend partially or completely around the rotation axis A and have a corresponding toothing on the side facing the coupling element 4. The spring 52 could then be a disc spring. Engagement of the two toothing would block rotation of the coupling element 4 or the output shaft 10 in the first rotational direction R1.

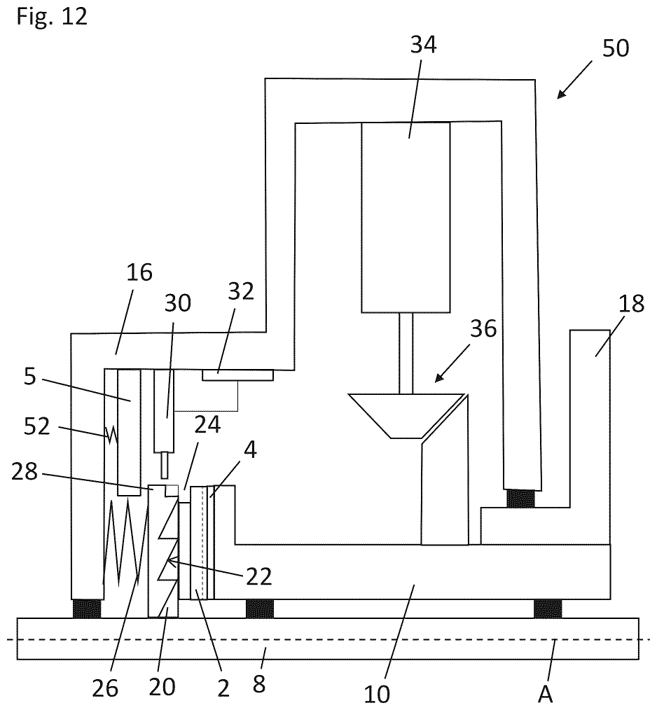

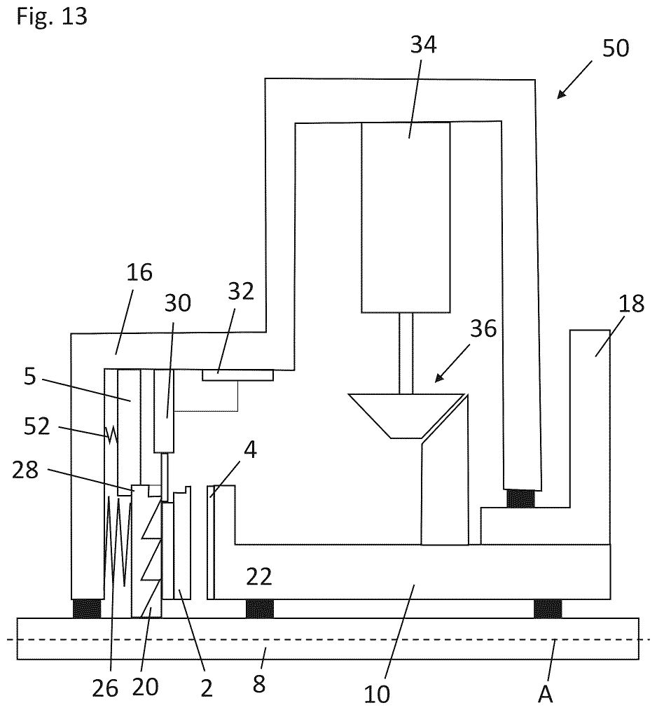

FIGS. 12 and 13 show another embodiment of the device 10. Unlike in FIGS. 10 and 11, the first coupling element 2 includes a stop area 28. The stop element 5 is coupled to the housing 16 via a spring 52 and is mounted so that it can move axially. As described above, the stop area 28 can have either one or more recesses or a toothing on the end face. The stop element 5 can be a bolt or extend around the rotation axis A (partially or completely) and can have a respective toothing. When the first coupling element 2 is pushed from the first axial relative arrangement (FIG. 12) into the second axial relative arrangement (FIG. 13), the stop area 28 engages with the stop element 5, for example, by the coupling element 2 first pressing the stop element 5 axially in the direction of the housing 16, thereby compressing the spring 52, which biases the stop element 5 axially in the direction of the stop area 28. When the rotational position of the coupling element 2 changes, the stop element 5 and the stop area 28 automatically engage at some point. Subsequently, the rotation of the coupling element 2 in the first rotational direction R1 is blocked.

The toothing of the stop element 5 and the stop area 28, 48 from the previous embodiments can, for example, be such that they block rotation of the stop area 28, 48 in the first rotational direction R1, but when rotating in the second rotational direction R2, the toothing are driven apart against the spring force of the spring 52, as in a freewheel. Rotation in the second rotational direction R2 would then be enabled.

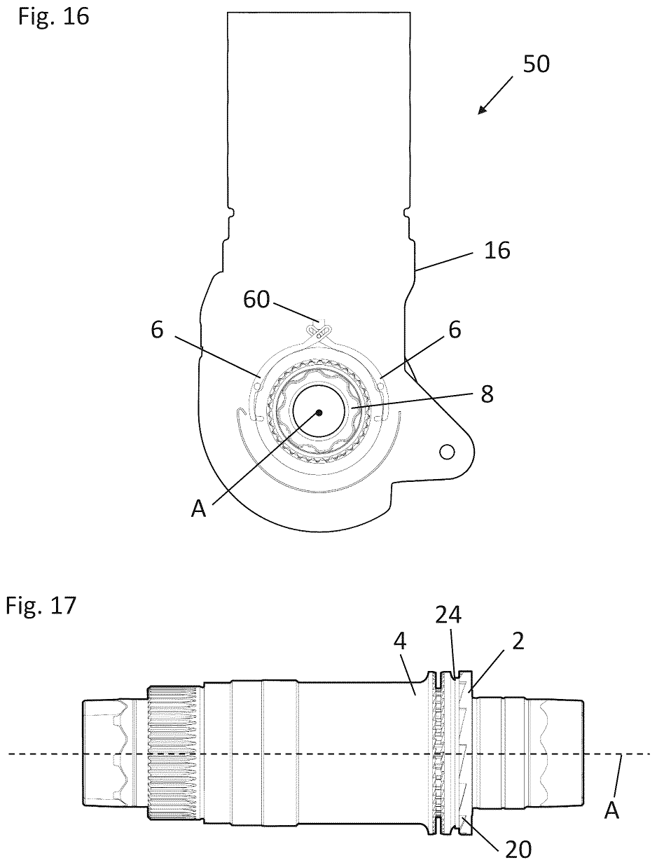

FIG. 16 shows a further embodiment of the device 50 in a view with the viewing direction parallel to the rotation axis A. Here, two blocking elements 6 are used, each of which is arcuate in shape and extends partially around the rotation axis A. The two blocking elements are coupled to an element 60 via a scissor joint. If the element 60 is moved upward via an actuator, the blocking elements 6 move radially inward and can then engage in the groove 24 if necessary.

FIG. 17 shows a part of the device of FIG. 16 in a top view with the viewing direction radially inward.

It is understood that the foregoing description is that of the preferred embodiments of the invention and that various changes and modifications may be made thereto without departing from the spirit and scope of the invention as defined in the appended claims.

### LIST OF REFERENCE SIGNS

2 first coupling element
4 second coupling element
5 stop element
6 blocking element
8 pedal shaft
10 output shaft
12 bicycle frame
14 down tube
16 housing
18 chainring/chainring spider
20 recess
22 inclined surface
24 groove
26 spring element
28 stop area
30 actuator
32 control unit
34 electric motor
36 gearbox
48 stop area
50 device
51 ring
52 spring
60 element
100 bicycle
A rotation axis
R1 first rotational direction
R2 second rotational direction

1. A device for a bicycle, the device comprising:
a first coupling element;
a second coupling element;
a movable blocking element;
said first coupling element and said second coupling element being mounted rotatably about a rotation axis and being mounted so as to be axially movable relative to each other;
the device being configured such that:
in a first axial relative arrangement of said first coupling element and said second coupling element, said first coupling element and said second coupling element are coupled to each other such that, at least when said first coupling element rotates in a first rotational direction, torque is transmittable to said second coupling element;
with the aid of rotation of said first coupling element in a second rotational direction, said first coupling element and said second coupling element are movable axially apart at least to a second axial relative arrangement;
in said second axial relative arrangement, movement of said movable blocking element into a blocking position is enabled or is configured to be enabled; and,
with said blocking element in said blocking position and said first coupling element and said second coupling element in said second axial relative arrangement, axial movement of said first coupling element and said second coupling element toward each other is blocked.

2. The device of claim 1, wherein, in said second axial relative arrangement, complete rotation of at least one of said first coupling element and said second coupling element in the first rotational direction is blocked.

3. The device of claim 2, wherein:
in said second axial relative arrangement, a stop area of one of said first coupling element and said second coupling element or a stop area coupled in a rotationally fixed manner to said one of said first coupling element and said second coupling element overlaps axially with a rotationally secured stop element, so that when said one of said first coupling element and said second coupling element rotates in the first rotational direction, said stop area strikes said stop element; and,
in said first axial relative arrangement, said stop area is axially offset relative to said stop element, so that said stop element does not block rotation of said one of said first coupling element and said second coupling element in the first rotational direction.

4. The device of claim 3, wherein:
said stop element is axially movably mounted; and,
said stop element is coupled to a spring to bias said stop element axially toward said stop area.

5. The device of claim 1, wherein:
in an axial relative arrangement in which the two coupling elements are closer to each other axially than in the second axial relative arrangement, movement of said blocking element into an intermediate position is enabled or is configured to be enabled, wherein, in said intermediate position, said blocking element engages with a recess arranged immovably relative to said first coupling element or said second coupling element and bounded by an inclined surface inclined with respect to the rotation axis; and,
starting from this axial relative arrangement and with said blocking element in said intermediate position, rotation of said first coupling element in the second rotational direction leads to movement of said inclined surface along said blocking element, whereby said first coupling element and said second coupling element are moved axially apart until said second axial relative arrangement is reached.

6. The device of claim 1, wherein the device is configured such that said blocking element is automatically moved into said blocking position as soon as said second axial relative arrangement is reached.

7. The device of claim 6, wherein the device is configured such that said blocking element is movable into a waiting position in which, when said first coupling element and said second coupling element are in an axial relative arrangement outside said second axial relative arrangement, said blocking element rests against said first coupling element or said second coupling element, and thereby a force is exerted on said blocking element which presses said blocking element in the direction of said blocking position against a corresponding one of said first coupling element and said second coupling element, wherein contact with said first coupling element or said second coupling element prevents movement of said blocking element into said blocking position.

8. The device of claim 7 further comprising:
a control unit;
an actuator signally coupled to said control unit; and,
said control unit being configured to generate a control signal for said actuator, wherein said control signal causes said actuator to move said blocking element into said waiting position or to release movement into said waiting position.

9. The device of claim 1, wherein:
said first coupling element or said second coupling element has a groove that extends at least partially around the rotation axis; and,
said blocking element protrudes into said groove in said blocking position.

10. The device of claim 1, wherein the movement of said blocking element into said blocking position is a radial movement with respect to the rotation axis.

11. The device of claim 1, wherein in said second axial relative arrangement, said first coupling element and said second coupling element are biased toward each other in a direction of said first axial relative arrangement via a spring element.

12. The device of claim 1, wherein said first coupling element and said second coupling element are freewheel elements which are in toothed engagement with each other in said first axial relative arrangement.

13. The device of claim 1, wherein:
the device is a drive device for the bicycle;
said first coupling element is coupled to a pedal shaft; and,
said second coupling element is coupled to an output shaft.

14. The device of claim 13, wherein the output shaft is coupled to an electric motor to transmit torque from the electric motor to the output shaft.

15. A bicycle comprising:
a pedal shaft;
an output shaft;
a drive device including a first coupling element, a second coupling element, and a movable blocking element;
said first coupling element and said second coupling element being mounted rotatably about a rotation axis and being mounted so as to be axially movable relative to each other;
said drive device being configured such that:
in a first axial relative arrangement of said first coupling element and
said second coupling element, said first coupling element and said
second coupling element are coupled to each other such that, at least
when said first coupling element rotates in a first rotational direction, torque is transmittable to said second coupling element;
with the aid of rotation of said first coupling element in a second rotational direction, said first coupling element and said second coupling element are movable axially apart at least to a second axial relative arrangement;
in said second axial relative arrangement, movement of said movable blocking element into a blocking position is enabled or is configured to be enabled; and,
with said blocking element in said blocking position and said first coupling element and said second coupling element in said second axial relative arrangement, axial movement of said first coupling element and said second coupling element toward each other is blocked;
said first coupling element being coupled to said pedal shaft;
said second coupling element being coupled to said output shaft;
said first coupling element being configured to be rotated in the first rotational direction by forward pedaling; and,
said first coupling element being configured to be rotated in the second rotational direction by backward pedaling.

16. A method for operating a device for a bicycle, the device including a first coupling element, a second coupling element, and a movable blocking element; the first coupling element and the second coupling element being mounted rotatably about a rotation axis and being mounted so as to be axially movable relative to each other; the device being configured such that:
in a first axial relative arrangement of the first coupling element and the second coupling element, the first coupling element and the second coupling element are coupled to each other such that, at least when the first coupling element rotates in a first rotational direction, torque is transmittable to the second coupling element;
with the aid of rotation of the first coupling element in a second rotational direction, the first coupling element and the second coupling element are movable axially apart at least to a second axial relative arrangement;
in the second axial relative arrangement, movement of the movable blocking element into a blocking position is enabled or is configured to be enabled; and,
with the blocking element in the blocking position and the first coupling element and the second coupling element in the second axial relative arrangement, axial movement of the first coupling element and the second coupling element toward each other is blocked; the method comprising:
exerting a force on the blocking element that acts in the direction of the blocking position; and,
rotating the first coupling element in the second rotational direction until the second axial relative arrangement is reached, in which the movement of the blocking element into the blocking position is enabled and the blocking element automatically moves into the blocking position.

17. The method of claim 16, wherein the device further includes a control unit and an actuator signally coupled to the control unit, and the control unit is configured to generate a control signal for the actuator, the method further comprising:
generating the control signal for the actuator, wherein the control signal causes the actuator to move the blocking element into the waiting position or to release movement into the waiting position, and the blocking element then automatically moves into the waiting position.

18. The method of claim 16, wherein the first coupling element is coupled to a pedal shaft and the second coupling element is coupled to an output shaft, wherein said rotating the first coupling element in the second rotational direction is effected by backward pedaling.
